(19) United States
(12) Patent Application Publication
(10) Pub. No.: US 2011/0243367 A1
(43) Pub. Date: Oct. 6, 2011

(54) MULTIFUNCTIONAL MICRO SPEAKER

(75) Inventors: Han-Ryang Lee, Gyeonggi-do (KR); Chung-Dam Song, Seoul (KR)

(73) Assignee: BSE CO., LTD., Incheon (KR)

(21) Appl. No.: 13/133,191

(22) PCT Filed: Aug. 31, 2009
(86) PCT No.: PCT/KR2009/004876

§ 371 Date: Jun. 7, 2011

(30) Foreign Application Priority Data
May 12, 2009 (KR) 10-2009-0041345

(51) Int. Cl. H04R 1/00

(52) U.S. Cl. 381/398

(57) ABSTRACT

A multifunctional micro speaker including a frame; a diaphragm having an outer circumferential portion fixed to the frame; a voice coil fixed to a lower surface of the diaphragm; a first member having one side fixed to the frame and having a predetermined elasticity; a yoke fixed to the first member and comprising a receiving groove; a first permanent magnet fixed to a bottom surface of the receiving groove; a plate fixed to an upper surface of the first permanent magnet; a second member having one side fixed to the frame, spaced apart from the first member in a downwards direction and having a predetermined elasticity; and a second magnet fixed to the second member and spaced apart from the first member and the yoke.

This application claims the benefit of Korean Patent Applications No. 10-2009-0041345, filed on May 12, 2009, in the Korean Intellectual Property Office, and the benefit of International Patent Application No. PCT/KR2009/004876, filed on Aug. 31, 2009, in the Korean Intellectual Property Office, the disclosures of which are incorporated herein in their entirety by reference.

### BACKGROUND OF THE INVENTION

1. Field of the Invention

One or more aspects of the present invention relate to a multifunctional micro speaker, and more particularly, to a multifunctional micro speaker including a speaker magnetic circuit, which is supported by an elastic member, and a magnet, which operates as a vibrator spaced apart from the speaker magnetic circuit and is supported by another elastic member, thereby improving acoustic features and vibration characteristics.

2. Description of the Related Art

A speaker is a device for converting an electrical signal into a voice signal. A micro speaker is a small-sized speaker used in small-sized portable audio devices such as cellular phones, notebook computers, MP3 players, earphones, and the like. Demand for such devices has risen sharply recently.

However, conventional electrical products employing a micro speaker, in particular, mobile communication devices such as cellular phones indispensably include a component for generating a vibration. That is, a conventional mobile communication device includes a component for generating a vibration that is frequently used instead of a sound to indicate an incoming call, or includes a component for generating a vibration to indicate an input state in a touch screen method in which information is input directly by touching a screen.

A multifunctional micro speaker as claimed in the present application further includes a component for generating a vibration, in addition to including a component for generating a sound as in a conventional micro speaker. A multifunctional micro speaker is variously referred to as a multifunctional actuator, a multifunctional electrical sound converter, or the like.

A conventional multifunctional micro speaker is configured to generate a vibration by making a vibrator supported by a plate-type spring resonate. The conventional multifunctional micro speaker includes a voice coil disposed in a magnetic circuit at a side of a diaphragm that is also referred to as a reed. Thus, when a voice signal current is supplied to the voice coil, a sound is output. In addition, when a vibration signal current is supplied to the voice coil, a vibration is generated.

A conventional multifunctional micro speaker 100 will now be described with reference to FIG. 1. The conventional multifunctional micro speaker 100 includes a case 110, a diaphragm 101 for generating a sound, a voice coil 102, a permanent magnet 104 of which N and S poles are vertically arranged, a plate 103, a yoke 105, a weight 106, an upper suspension 107, and a lower suspension 108. A current is supplied to the voice coil 102 through a lead wire a 114 and a lead wire b 115.

An upper end portion of the voice coil 102 is fixed to a lower surface of the diaphragm 101. The voice coil 102 is wound in a downward direction. The plate 103 is fixed to an upper surface of the permanent magnet 104. The permanent magnet 104, the plate 103, and the yoke 105 constitute a speaker magnetic circuit. The weight 106, the permanent magnet 104, the plate 103, and the yoke 105 constitute a vibrator. The vibrator is elastically supported against the case 110 by the upper suspension 107 and the lower suspension 108.

When a current is supplied to the voice coil 102 of the conventional multifunctional micro speaker 100 through the lead wire a 114 and the lead wire b 115, an electromagnetic force is generated in the voice coil 102, and thus, the diaphragm 101 vibrates and a sound is output.

That is, a magnetic line of force emitted from the N pole of the permanent magnet 104 forms a magnetic field oriented towards the S pole of the permanent magnet 104 through the plate 103, the voice coil 102, and the yoke 105 in the order stated. In this case, when the electromagnetic force is generated in the voice coil 102, the electromagnetic force interacts with magnetic flux generated due to a magnetic circuit, and the diaphragm 101 fixed to the voice coil 102 vibrates, thereby functioning as a speaker for outputting a sound.

When a low frequency current is supplied to the voice coil 102 through the lead wire a 114 and the lead wire b 115, the low frequency current triggers an up-and-down motion of the vibrator that further includes the weight 106 in addition to the permanent magnet 104, the plate 103, and the yoke 105, which constitute the speaker magnetic circuit, to thus generate a vibration.

However, since the speaker magnetic circuit and the vibrator share the same components in the conventional multifunctional micro speaker, various problems arise. That is, a motion of the vibrator interferes with a motion of the diaphragm, thereby resulting in noise being generated. In addition, since it is difficult to constantly keep upper and lower suspensions level relative to each other, an unstable vibration may be generated.

In addition to the above-mentioned conventional speaker, a speaker including a plurality of voice coils has been developed. However, this speaker has a complicated structure and space is inefficiently used by a vibrator, and thus, there is a limit in improving a vibrating force.

### SUMMARY OF THE INVENTION

One or more aspects of the present invention provide a multifunctional micro speaker including a vibrator that is spaced apart from a magnetic circuit but is connected to the magnetic circuit through a magnetic field to thus reduce vibration and noise and minimize motion interference between the vibrator and the magnetic circuit.

According to an aspect of the present invention, there is provided a multifunctional micro speaker including a frame; a diaphragm having an outer circumferential portion fixed to the frame; a voice coil fixed to a lower surface of the diaphragm; a first member having one side fixed to the frame and having a predetermined elasticity. a yoke fixed to the first member and including a receiving groove; a first permanent magnet fixed to a bottom surface of the receiving groove; a plate fixed to an upper surface of the first permanent magnet; a second member having one side fixed to the frame, spaced apart from the first member in a downwards direction, and having a predetermined elasticity; and a second magnet fixed to the second member and spaced apart from the first member and the yoke.

At least one of the first member and the second member may have a plate shape.

The first member and the second member may have a plate shape, the first member may have an outer circumferential portion fixed to the frame, the yoke may be fixed to an upper surface of the first member, the second member may have an outer circumferential portion fixed to the frame, and the second magnet may be fixed to an upper surface of the second member.

The first member and the second member may have a plate shape, the first member may have an outer circumferential portion fixed to the frame, the yoke may be fixed to an upper surface of the first member, the second member may have an outer circumferential portion fixed to the frame, the second magnet is fixed to a lower surface of the second member, and the first member and the second member may face each other, may be spaced apart from each other, and may be disposed parallel to each other.

N and S poles of the first permanent magnet may be arranged from a top portion to a bottom portion, and the second magnet may be a permanent magnet of which S and N poles are arranged from a top portion to a bottom portion, or a permanent magnet of which N and S poles are arranged from a top portion to a bottom portion.

The second magnet may be an electromagnet.

The first member has a plate shape, and a third magnet may be disposed on a lower surface of the first member or a lower surface of the yoke. In addition, N and S poles of the third magnet may be arranged from a top portion to a bottom portion.

At least one of the second member and the second magnet may include a solid member.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic cross-sectional view of a conventional multifunctional micro speaker;

FIG. 2 is a perspective view of a portion of a multifunctional micro speaker according to an embodiment of the present invention;

FIG. 3 is a schematic exploded perspective view of the multifunctional micro speaker of FIG. 2;

FIG. 4 is a schematic cross-sectional view of the multifunctional micro speaker;

FIG. 5 is a cross-sectional view of a multifunctional micro speaker according to another embodiment of the present invention; and

FIG. 6 is a cross-sectional view of a multifunctional micro speaker according to another embodiment of the present invention.

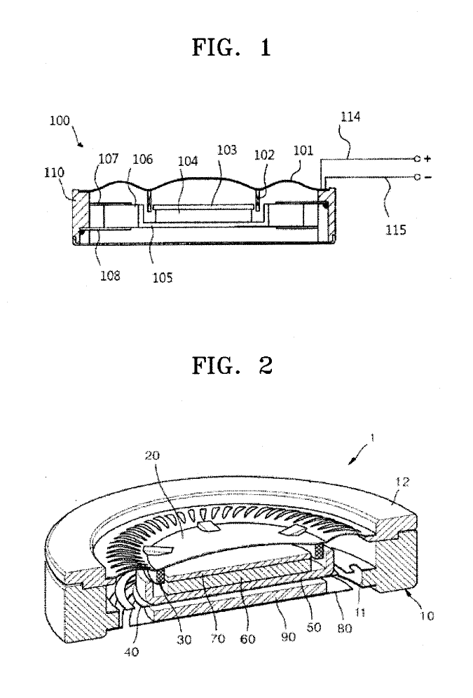

### DETAILED DESCRIPTION OF THE INVENTION

A multifunctional micro speaker according to an embodiment of the present invention will be described in detail with reference to FIGS. 2 through 4.

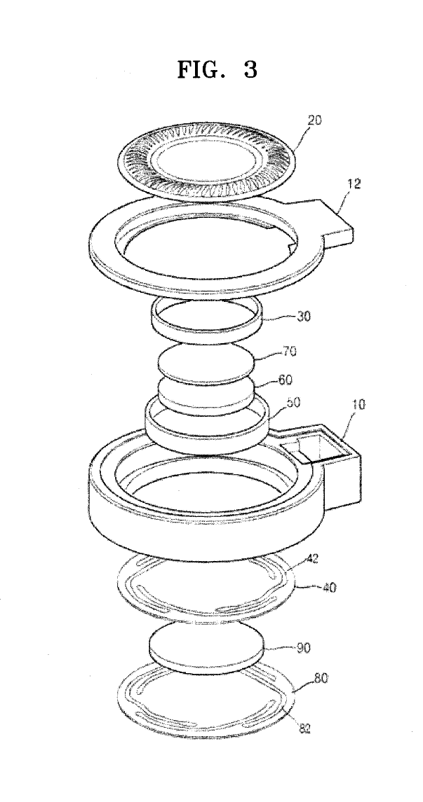

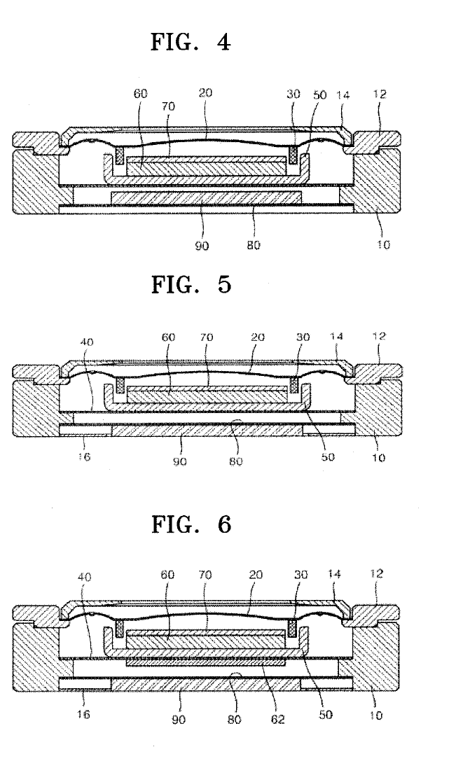

FIG. 2 is a perspective view of a portion of a multifunctional micro speaker 1 according to an embodiment of the present invention. FIG. 3 is a schematic exploded perspective view of the multifunctional micro speaker 1 of FIG. 2. FIG. 4 is a schematic cross-sectional view of the multifunctional micro speaker 1 of FIG. 2.

The multifunctional micro speaker 1 is mainly used in mobile communication devices such as cellular phones, or small-sized devices such as portable multimedia players (PMPs), and has both a function of generating a sound, like a speaker, and a function of generating a vibration, as a signal.

The multifunctional micro speaker 1 includes a frame 10, a diaphragm 20, a voice coil 30, a first member 40, a yoke 50, a first permanent magnet 60, a plate 70, a second member 80, and a second magnet 90.

The frame 10 is generally formed of plastic and forms an outer appearance of the multifunctional micro speaker 1. Various components are fixed to an inner part of the frame 10. The frame 10 further includes an upper frame 12 disposed thereon. A cover member 14 is coupled to the upper frame 12. For convenience of illustration, the cover member 14 is illustrated in FIG. 4 only. According to the present embodiment, the frame 10 has an overall cylindrical shape.

An outer circumferential portion of the diaphragm 20 is fixed between the upper frame 12 and the cover member 14. An assembly obtained by coupling the upper frame 12, the cover member 14, and the diaphragm 20 to each other is coupled to the frame 10 that functions as a body, and thus, an assembly process may be effectively performed.

The diaphragm 20 generates a sound pressure that is audible to human ears while vibrating vertically. As described above, the outer circumferential portion of the diaphragm 20 is fixed to the frame 10. The diaphragm 20 is generally formed of a high-molecular weight compound.

According to the present embodiment, the diaphragm 20 is divided into an inner portion and an outer portion, with respect to a boundary portion to which an upper end portion of the voice coil 30 is fixed. Each of the inner portion and the outer portion has a dome shape. The boundary portion is flat. The outer portion is also referred to as an edge. According to the present embodiment, in consideration of an acoustic feature, the outer portion includes a plurality of comb-shaped grooves formed in a circumferential direction thereof. The diaphragm 20 may be changed in various ways in terms of shape, material and thickness.

The voice coil 30 is fixed to a lower surface of the diaphragm 20. The upper end portion of the voice coil 30 is fixed to a lower surface of the boundary portion of the diaphragm 20. The voice coil 30 is formed by winding a wire in an upward direction. The voice coil 30 is electrically connected to a terminal (not shown) included in the frame 10. The voice coil 30 receives a current from an external source thorough the terminal.

A lower portion of the voice coil 30 is disposed in a space between the plate 70 and the yoke 50. When a high frequency current flows through the voice coil 30, the voice coil 30 moves up and down due to interaction between the high frequency current and a magnetic field formed by the first permanent magnet 60. Thus, the diaphragm 20 coupled to the voice coil 30 vibrates to thus generate a sound.

The first member 40 has a predetermined elasticity. One side of the first member 40 is fixed to the frame 10. Elasticity is a property of a material that returns to its original volume and shape after an external deformation force is removed, and is classified into volume elasticity and shape elasticity according to the deformation type. According to the present embodiment, the first member 40 has mainly shape elasticity.

According to the present embodiment, the first member 40 has a plate shape, for example, a disk shape so as to correspond to the shape of the frame 10. The first member 40 is formed of plate-shaped metal material, such as phosphor bronze. According to another embodiment of the present invention, the first member 40 may be formed of a high-molecular weight elastic material.

An outer circumferential portion of the first member 40 is fixed to an upper surface of a protrusion 11 that protrudes from an inner lateral wall of the frame 10. The yoke 50 is fixed to a central portion of the first member 40. A plurality of elongated holes 42 that extend in a circumferential direction of the first member 40 are formed through the first member 40, except for the outer circumferential portion fixed to the frame 10 and the central portion fixed to the yoke 50.

Since the first member 40 includes the elongated holes 42, a desired elastic deformation may be obtained. A vibration width of the diaphragm 20 may be controlled by changing the shapes of the elongated holes 42.

The yoke 50 is fixed to the first member 40. A concave receiving groove is formed in an inner surface of the yoke 50. The yoke 50 is formed of a material through which a magnetic force is smoothly transmitted.

The first permanent magnet 60 is formed to have a disk shape so as to correspond to the receiving groove of the yoke 50. The first permanent magnet 60 is fixed to an inner bottom surface of the yoke 50. The first permanent magnet 60 is a permanent magnet of which N and S poles are arranged from a top portion thereof to a bottom portion thereof.

The plate 70 has almost the same diameter as the first permanent magnet 60, and is fixed to an upper surface of the first permanent magnet 60. The plate 70 is formed of a material through which a magnetic force is smoothly transmitted.

The first permanent magnet 60 and the plate 70 are spaced apart from an inner lateral wall of the yoke 50 and are fixed to the yoke 50. A space is formed between the inner lateral wall of the yoke 50 and external lateral surfaces of the first permanent magnet 60. The lower portion of the voice coil 30 is disposed in the space.

The first permanent magnet 60, the plate 70, and the yoke 50 constitute a speaker magnetic circuit. That is, a magnetic flux generated by the first permanent magnet 60 forms a magnetic flux path that is transmitted to the yoke 50 through the plate 70.

The second member 80 is disposed below the first member 40 so as to be spaced apart from the first member 40. Similar to the first member 40, one side of the second member 80 is fixed to the frame 10, and the second member 80 has a predetermined elasticity.

According to the present embodiment, the second member 80 is formed of the same material and has the same shape as the first member 40. However, according to another embodiment of the present invention, the shapes and materials of the first member 40 and the second member 80 may not be the same, and may be changed in various ways, in consideration of a resonance frequency, displacement, and vibrating force.

An outer circumferential portion of the second member 80 is fixed to a lower surface of the protrusion 11 that protrudes from the inner lateral wall of the frame 10. Also, a plurality of elongated holes 82 are formed through the second member 80.

The second magnet 90 is fixed to the second member 80. The second magnet 90 is spaced apart from the first member 40 and the yoke 50 and is fixed to the second member 80. According to the present embodiment, since the yoke 50 is fixed to an upper surface of the first member 40. If the second magnet 90 is spaced apart from the first member 40, the second magnet 90 is also spaced apart from the yoke 50. However, according to another embodiment, when the first member 40 has a shape other than a plate shape, the second magnet 90 needs to be spaced apart from the yoke 50 as well as the first member 40.

According to the present embodiment, the second magnet 90 is fixed to an upper surface of the second member 80. The second magnet 90 is a permanent magnet of which S and N poles are arranged from a top portion thereof to a bottom portion thereof; Thus, a repulsive force acts between the second magnet 90 and the first permanent magnet 60 of which N and S poles are arranged from a top portion thereof to a bottom portion thereof so that the second magnet 90 and the first permanent magnet 60 repel each other.

According to the present embodiment, the second magnet 90 is a permanent magnet of which S and N poles are arranged from a top portion thereof to a bottom portion thereof, but is not limited thereto. Alternatively, in the second magnet 90, the N and S poles are arranged from a top portion thereof to a bottom portion thereof. In addition, the second magnet 90 may be an electromagnet instead of a permanent magnet. If the second magnet 90 is an electromagnet, the poles may be changed like in the case of a permanent magnet. Likewise, by changing the arrangement of the N pole and the S pole of the second magnet 90, desired vibration characteristics of a vibrator may be obtained. The second magnet 90 and the second member 80 may constitute the vibrator.

Hereinafter, the operation and effect of the multifunctional micro speaker 1 will be described.

In the multifunctional micro speaker 1, although the vibrator including the second magnet 90 and the second member 80 is spaced apart from the speaker magnetic circuit including the first permanent magnet 60, the plate 70, and the yoke 50, since the vibrator and the speaker magnetic circuit are connected to each other through a magnetic field, a vibration motion of the diaphragm 20 for generating a sound and a vibration motion of the vibrator including the second magnet 90 and the second member 80 may minimally interfere with each other.

That is, in the conventional multifunctional micro speaker, since an assembly that constitutes a magnetic circuit functions as a vibrator, a motion of a diaphragm for generating a sound and a vibration motion of the assembly that constitutes the magnetic circuit and functions as the vibrator conflict with each other. However, according to an embodiment of the present invention, in the multifunctional micro speaker, a vibrator is formed by a second magnet and a second member so as to be spaced apart from components constituting a magnet circuit, and thus, the problem of the conventional multifunctional micro speaker is remarkably overcome.

According to an embodiment of the present invention, the multifunctional micro speaker is configured in such a way that the speaker magnetic circuit and the vibrator are physically spaced apart from each other but are connected through a magnetic field. Thus, the speaker magnetic circuit may vibrate with minimum displacement, and simultaneously may operate as a vibration source for a vibration of a vibrator. That is, the multifunctional micro speaker is configured in such a way that a displacement amplitude of the magnetic circuit is minimized and a displacement amplitude of a magnet vibrator is maximized, and thus, a change in an acoustic performance of a speaker may be minimized and a function of a vibrator may be simultaneously performed. Thus, the displacement amplitude and damping characteristics may be effectively used. In addition, vibration noise may be reduced and manufacturing costs may be reduced due to a simple structure of the multifunctional micro speaker.

Sound and vibration may be truly reproduced by using only a single voice coil. Driving interference between the diaphragm 20 and the vibrator may be prevented and a reduction in driving forces of the diaphragm 20 and the vibrator may be prevented.

Since the interference between the diaphragm 20 and the vibrator is minimized, it is easy to change or control the characteristics of the vibrator and the diaphragm 20 for generating sound.

A resonance frequency and a vibrating force may be controlled by adjusting a degree of elasticity of the second member 80 and a magnetic force of the second magnet 90.

In addition, the resonance frequency and the vibration force may be further controlled by adjusting weights of the vibrator and the speaker magnetic circuit.

According to the present embodiment, the first and second members 40 and 80 may also be referred to as first and second suspensions. The first and second members 40 and 80 are each an member shaped like a plate spring, but the present invention is not limited thereto. That is, the first and second members 40 and 80 may be changed in various ways to have any three-dimensional shape other than a plate shape, for example, a coil-spring shape or a three-dimensional curved shape.

FIGS. 5 and 6 show multifunctional micro speakers according to other embodiments of the present invention.

The multifunctional micro speaker of FIG. 5 is different from the multifunctional micro speaker 1 of FIG. 2 in that the second magnet 90 is fixed to a lower surface of the second member 80. Thus, compared to the multifunctional micro speaker 1 of FIG. 2, a vibration width of a vibrator is further ensured, and distribution of a magnetic field formed between a magnetic circuit and the vibrator may be uniform. However, except for this feature of the multifunctional micro speaker of FIG. 5, the multifunctional micro speaker of FIG. 5 is the same as the multifunctional micro speaker 1 of FIG. 2 in terms of construction, and thus, the same operation and effect may be obtained due to the same construction. A lower cover 16 is disposed at a lower end portion of the frame 10.

The multifunctional micro speaker of FIG. 6 is different from the multifunctional micro speaker 1 of FIG. 2 in that a third magnet 62 is disposed on a lower surface of the first member 40. According to the present embodiment, the third magnet 62 is a permanent magnet of which N and S poles are arranged from a top portion thereof to a bottom portion thereof.

According to the present embodiment, the third magnet 62 may reinforce a magnetic force of the first permanent magnet 60. In addition, by increasing a total weight of components constituting a magnetic circuit, a vibration width and vibration speed of the vibrator may be increased. Except for this feature of the multifunctional micro speaker of FIG. 6, the multifunctional micro speaker of FIG. 6 is the same as the multifunctional micro speaker 1 of FIG. 2 in terms of construction, and thus, the same operation and effect may be obtained due to the same construction.

According to another embodiment of the present invention, although not illustrated, a solid member may be further included in at least one of a second member and a second magnet. That is, the solid member with a desired weight may be disposed at one side of any one of the second magnet and the second member, which constitute the vibrator. If necessary, solid members may be included in both the second magnet and the second member. By adding the solid member, a resonance frequency and a vibration force may be improved.

In a multifunctional micro speaker according to one or more embodiments of the present invention, an interference between a diaphragm for generating sound and a vibrator generating vibration may be minimized.

A displacement amplitude of a speaker magnetic circuit may be minimized and a displacement amplitude of a vibrator may be maximized.

Since the interference between the speaker and vibrator is minimized, the characteristics of the speaker and vibrator may be easily changed and improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multifunctional micro speaker comprising:
a frame;
a diaphragm having an outer circumferential portion fixed to the frame;
a voice coil fixed to a lower surface of the diaphragm;
a first member having one side fixed to the frame and having a predetermined elasticity;
a yoke fixed to the first member and comprising a receiving groove;
a first permanent magnet fixed to a bottom surface of the receiving groove;
a plate fixed to an upper surface of the first permanent magnet;
a second member having one side fixed to the frame, spaced apart from the first member in a downwards direction, and having a predetermined elasticity; and
a second magnet fixed to the second member and spaced apart from the first member and the yoke.

2. The multifunctional micro speaker of claim 1, wherein at least one of the first member and the second member has a plate shape.

3. The multifunctional micro speaker of claim 2, wherein the first member and the second member have a plate shape,
wherein the first member has an outer circumferential portion fixed to the frame,
wherein the yoke is fixed to an upper surface of the first member,
wherein the second member has an outer circumferential portion fixed to the frame, and
wherein the second magnet is fixed to an upper surface of the second member.

4. The multifunctional micro speaker of claim 2, wherein the first member and the second member have a plate shape,
wherein the first member has an outer circumferential portion fixed to the frame,
wherein the yoke is fixed to an upper surface of the first member,
wherein the second member has an outer circumferential portion fixed to the frame,
wherein the second magnet is fixed to a lower surface of the second member, and
wherein the first member and the second member face each other, are spaced apart from each other, and are disposed parallel to each other.

5. The multifunctional micro speaker of claim 1, wherein N and S poles of the first permanent magnet are arranged from a top portion to a bottom portion, and
wherein the second magnet is a permanent magnet of which S and N poles are arranged from a top portion to a bottom portion.

6. The multifunctional micro speaker of claim 1, wherein N and S poles of the first permanent magnet are arranged from a top portion to a bottom portion, and
wherein the second magnet is a permanent magnet of which N and S poles are arranged from a top portion to a bottom portion.

7. The multifunctional micro speaker of claim 1, wherein the second magnet is an electromagnet.

8. The multifunctional micro speaker of claim 1, wherein the first member has a plate shape, and
wherein a third magnet is disposed on a lower surface of the first member or a lower surface of the yoke.

9. The multifunctional micro speaker of claim 8, wherein N and S poles of the third magnet are arranged from a top portion to a bottom portion.

10. The multifunctional micro speaker of claim 1, wherein at least one of the second member and the second magnet comprises a solid member.
